(19) United States
(12) Patent Application Publication
(10) Pub. No.: US 2007/0289617 A1
(43) Pub. Date: Dec. 20, 2007

(54) Apparatus and method for cleaning and stimulating reservoirs

(76) Inventors: Dana Wayne Lofton, Houma, LA (US); Thurman Eddie Lofton, Theriot, LA (US)

Correspondence Address: MICHAEL D. CARBO, 1220 PINE STREET, NEW ORLEANS, LA, 70118, US

(21) Appl. No.: 11/452,491

(22) Filed: Jun. 14, 2006

(51) Int. Cl. B08B 9/00; B08B 3/12

(52) U.S. Cl. 134/166 R; 134/184

(57) ABSTRACT

A system for cleaning, treating, and/or stimulating a reservoir in a high pressure, low volume application or a low pressure, high volume application, comprising: a thermal fluid heater capable of generating energy in the form of superheated air that is circulated through the heater to heat a working fluid that is forced through tubes within the heater: an air compressor for atomizing the fuel and creating a fuel/air mixture; a blower for blowing ambient air into the atomized fuel/air mixture in the heater to raise the temperature of the working fluid; a charge pump on the intake side of the heater for forcing the working fluid through the heater at a pressure and volume sufficient to supply the working fluid to an outlet of the heater; a discharge pump on the outlet side of the heater to increase the pressure of the working fluid as it exits the system to a sufficient pressure and volume to clean, treat, and/or stimulate the reservoir for a particular selected application; and a prime mover or prime movers for powering the pumps, the air compressor and the blower. The heater, fuel pump, air compressor, blower, charge pump, discharge pump, and prime mover means are disposed on a portable frame or skid that can be transported conveniently.

### CROSS-REFERENCE TO RELATED APPLICATIONS

None

### STATEMENT REGARDING FEDERALLY SPONSORED RESEARCH

None

### NAMES OF PARTIES TO A JOINT RESEARCH AGREEMENT

None

### REFERENCE TO A “SEQUENCE LISTING”

None

### BACKGROUND OF THE INVENTION

1. Field of the Invention

The invention relates generally to injecting heated liquids into reservoirs, vessels, tanks, holds, other storage units, and flow lines. More particularly, the invention relates to a method for cleaning or treating reservoirs, vessels, tanks, holds, other storage units, or flow lines by injecting therein heated fluids under pressure, a system embodying the method, and apparatus for use in the method and system.

2. Description of Related Art, Including Information Disclosed Under 37 CFR 1.97 and 37 CFR 1.98

Apparatus and methods exist to clean or treat reservoirs. In the broadest sense, a reservoir is a vessel, tank, hold, other storage unit, or a pipeline or other flow line. Apparatus and methods for cleaning reservoirs in this broad sense can include apparatus and methods that inject, under pressure, a cleaning, dispersing, treating, neutralizing, or stimulating agent into the reservoir. Methods for cleaning or treating reservoirs include applying heated fluid or chemicals under pressure to loosen, disperse, or dissolve “contaminants.” The particular working materials (that is, the composition of the fluid), the temperature of the working materials, and the pressure at which the working materials are introduced into a reservoir depend on the characteristics of the contaminant, which can vary from reservoir to reservoir.

Particular working materials can include, among others, hot water, either fresh or salt, gun barrel water (also known as produced water), heated diesel fuel, heated produced oil, raw chemicals (such as xylene or benzene, either with or without water or diesel oil or heated oil), or heated chemicals. Selecting particular working materials depends significantly on the particular characteristics of the “contaminant” and on the particular application. Applications can include, among others, down hole oil wells or gas wells, vessel storage tanks, vessel holds, pipelines, pig traps, storage tanks, holding tanks, and towers (such as cat crackers, fractionation towers, and emulsifiers). Selection of appropriate temperature and pressure also depends on the application.

European patent 032813 describes a process for the removal of sludges from crude or refined oil storage tanks by injecting a dispersing agent into the sludge by means of a water jet. The emulsified oil fractions are removed under pressure and recirculated to the jet. The sludge is physically and chemically altered so that it can be pumped and easily removed from the tank, the emulsion being further mixed to an oil volume sufficient to cause the sludge separation, the water layer being separated and the heavy hydrocarbons recovered.

Japanese publication J 58 030398 describes the treatment of sludges by adding an amount of solvent and heating by circulating in the oil furnace to extract paraffin waxes and separating solid constituents from the oil fraction.

The so-called T.H.O.R. process is a mechanical system for the recovery of hydrocarbons from the oil sludge and contaminated oil tank bottoms. The process involves penetrating the sludge bulk with a hot water circulating system using a submersible pump. The T.H.O.R. process comprises two stages: sludge moving and sludge refining. To render the sludge mobile, water heated with refinery steam is pumped into the tank to lower the viscosity of the sludge so as to optimize its pumping and recovery. The mobile sludge is pumped through a submersible pumping unit placed in the medium to be pumped. The amount of water placed into the tank is equivalent to that of the sludge to be moved. The water is kept circulating during the whole liquefaction period of the tank contents, which normally takes 7 to 8 days. The pumping process has a maximum flow rate of 15000 liters per hour, the mass being pumped corresponding to a ratio of 50% water/50% sludge. The mixture is pumped through Alfa Laval equipment for the removal of insoluble foreign matter and water so as to produce oil to be reintroduced in the refining process. The recovered product, of BSW lower than 1% and low conductivity, is mixed to crude oil in predetermined amounts. The so-called “SUPERMACS” system developed by Riedel Environmental Technologies Inc. employs heated water jets under high average pressure, in order to melt and heat paraffin and sludge deposits. The products are separated and recovered based on their different densities, the oil contained in the sludge also being recovered.

U.S. Pat. No. 5,580,391 discloses a process for the thermochemical cleaning of a sludge-containing storage tank for petroleum oil or a similar material which comprises: adding to said sludge in said tank an organic solvent or mixture of solvents which fluidizes the said sludge, the volume ratio of solvent: sludge being in the range of 0.5:1 to 2.5:1; adding to the mixture of sludge and organic solvent an aqueous nitrogen-generating system comprising a reducing nitrogen salt, an oxidizing nitrogen salt and an acid activator which interact to generate nitrogen and heat, thereby causing thorough mixing of the said sludge, the said solvent, and the said aqueous nitrogen-generating system; allowing the contents of the said tank to separate to form an oil phase consisting essentially of the said solvent and the organic constituents of the said sludge, a saline aqueous phase comprising the residue of the nitrogen generating system, and, if present, the solid inorganic constituents of the said sludge; removing the oil phase and recovering the solvent and other valuable constituents therefrom; removing the aqueous phase and sending it to effluent treatment; and if required removing also any solid inorganic residue remaining in said tank. In this process sludges of crude or refined oil, stored in tanks or any other kind of container, are fluidized and the oil contained therein is recovered by the addition of a solvent having the correct properties to fluidize the sludge, followed by the addition of aqueous solutions of inorganic salts that generate nitrogen and heat.

Size, weight, and portability are desirable advantages because the apparatus and system is economically advantageous to the extent that it can conveniently travel, offshore, for example, without taking up too much room or being too heavy. To clean mud tanks on an offshore vessel typically often requires the offshore vessel to leave a mud-cleaning site at an oil well and travel to a port facility where cleaning of the vessel hold or mud storage tanks can occur. Conventional mud cleaning apparatus are not sufficiently portable because the combination of equipment that is conventionally used takes up too much weight and volume and too large a footprint to be carried conveniently on the vessel. The combination of pumping capacity (i.e., flow volume) and pumping pressure to accomplish effective cleaning of mud tanks or holds while a vessel is underway or at a well site would be desirable and does not presently exist in a versatile, portable package that would make such cleaning economically efficient.

Consequently, it is an object of the present invention to provide new apparatus and systems that will overcome the drawbacks in existing apparatus and systems and a new method of cleaning vessel holds that can be accomplished in transit and does not require as much vessel downtime in port as do conventional cleansing methods. It is also an object of the present invention to provide a portable cleaning, treating, and stimulating apparatus and system that is lighter than 25,000 pounds and preferably lighter than 16,000 pounds and that has a small footprint, preferably less than about 9′ by 16′ for a high pressure, low volume application and preferably less than 6′ by 9′ for a low pressure, high volume application.

It is a further object of the invention to provide a new system that can efficiently and in a relatively small package generate between approximately 750 k Btu and approximately 12 MM Btu of energy to heat a working fluid sufficiently at the desired pressure and volume flow rate, depending on the desired application.

### BRIEF SUMMARY OF THE INVENTION

An object of the invention is to provide portable cleaning, treating, and stimulating apparatus and system packages that are lighter than 25,000 pounds and preferably lighter than 16,000 pounds and that have a small footprint, preferably less than about 9′ by 16′ for high pressure, low volume applications and preferably less than 6′ by 9′ for low pressure, high volume applications. The system according to the present invention includes a frame or skid on which the apparatus is placed to create a sufficiently small footprint. The height of the package is preferably less than 8′. The frame or skid can have a drip pan or otherwise be sealed at its bottom.

The system, apparatus, and method according to the present invention include a thermal fluid heater, preferably a single-pass heater, capable of generating between approximately 750 k Btu and approximately 12 MM Btu of energy to heat sufficiently a working fluid at the desired pressure and volume flow rate, which will depend on the particular application. The lower energy would be useful in cleaning small tanks and reservoirs where the desired temperature to be achieved is between ambient and about 350 to 400 degrees F. at a volume flow rate of 25-30 gallons (about ½ barrel) per minute and where the desired pressure is between 100 and 10,000 psi.

The thermal fluid heater has an array of plates and coils that transfer heat to fluids. A preferred thermal fluid heater for a low pressure, high volume application is a Gentex 7M model single-pass thermal heater, which can produce 7 MM Btu of heat to clean economically an approximately 2,200 barrel tank at a temperature between ambient and about 350 to 400 degrees F. at a volume flow rate of up to about 200 gallons per minute (about 4½ barrels per minute) and a pressure typically between approximately 25 psi and approximately 200 psi. The pressure of the working fluid can be adjusted by adjusting the output of a discharge pump attached to the heater. Tanks of up to 4,000 barrels could be cleaned with a Gentex 7M model single-pass thermal heater when used in combination with the other apparatus of the system according to the present invention.

A preferred thermal fluid heater for a high pressure, low volume application is a Gentex 3.5 M model single-pass thermal heater, which can produce 3.5 MM Btu of heat to inject heated fluids into reservoirs under pressure, including production systems such as wells, other geological formations, flow lines, transfer lines, and production or refinery equipment. High pressure, low volume applications comprise temperatures between ambient and about 350 to 400 degrees F. at a volume flow rate of up to approximately 84 gallons per minute (about 2 barrels per minute) and a pressure typically between approximately 50 psi and 10,000 psi. The working fluid can be selectively discharged from the system at between approximately 25 psi and approximately 10,000 psi at a flow rate between approximately 3 gallons per minute and approximately 84 gallons per minute, at a temperature ranging from ambient to approximately 400 degrees F. Selective discharge flow rates and pressures can be accomplished by varying the speed of the prime mover.

The thermal fluid heater has a fuel pump that forces fuel through a heater nozzle and which works in sync with an air compressor to atomize the fuel to provide a clean mixture of air and fuel. A Viking FH432 model fuel pump or any fuel pump that can flow up to approximately 90 gallons per hour at approximately 130 psi can be used. The system according to the invention also includes a blower, preferably a Cincinnati Fan Model 15A, that takes ambient air and blows it into a firebox of the heater from which the air ultimately discharges air out of an exhaust stack, as well as an air compressor, preferably a W.W. Granger model 247B air compressor, which is used to atomize the fuel that is supplied, preferably from off of the frame or skid. Any air compressor that provides 3.9 to 4.5 cfm could be used. Superheated air is blown across the coils of the heater that contains the pumped working fluid to heat the fluid to a sufficient temperature. The heated fluid is then discharged under sufficient pressure and at sufficient volume to accomplish a desired application. Alternatively, the heater could be valved off for ambient temperature applications.

The system according to the invention also includes a charge pump on the intake side of the heater for charging (i.e., forcing fluid through) the heater and, preferentially, a discharge pump that could terminate in a discharge port or a nozzle, depending on the application. Depending on the application, the heater intake pump could be used alone and the discharge pump could be valved off. For a low pressure, high volume application, the pumps are preferably Mission Magnum model centrifugal pumps having a 13″ casing and an 8″ impeller. These are space-saving pumps that bolt to a Marathon motor. These pumps in operation should be limited to 250 psi because the casing is tested to 300 psi. For a high pressure, low volume application, the pumps are preferably Peerless model centrifugal pumps having an 8″ casing and an 8″ impeller.

A prime mover drives the two pumps, the air compressor, and the blower. In a low pressure, high volume application, the prime mover preferably includes four motors, one 75 HP motor to power each of the pumps, one 7½ HP motor to drive the blower, and one 3 HP motor, having a double-ended shaft producing 850 rpm, to power the fuel pump and air compressor. Alternatively, a single prime mover could be used for powering all equipment. The prime mover could be hydraulic, electric, or diesel, or a combination.

In a high pressure, low volume application, the prime mover preferably includes two motors, one 45 HP motor to power the charge pump, fuel pump, air compressor, and blower, and one 140 HP motor to drive a positive displacement pump, preferably a triplex pump. Except for the heater, which should be a thermal fluid heater, the apparatus of the system could be electric, diesel, hydraulic, or a combination of same, which eliminates the need for fan belts, thereby eliminating alignment problems and some maintenance down time. The present invention can be operated using diesel pumps for high-pressure, low volume applications.

Accordingly, it is an object of the present invention to provide a new and more effective method for cleaning or treating reservoirs, vessels, tanks, holds, other storage units, or flow units by injecting therein, heated fluids under pressure by means of the apparatus and system of the present invention.

It is also an object of the present invention to provide a new method and a new system and apparatus that is more cost efficient than conventional methods, systems, and apparatus. These and other objects and advantages are apparent from the description of the invention, taken in conjunction with the drawing, can be learned by practice of the invention, or are apparent to a person of ordinary skill in the art.

### BRIEF DESCRIPTION OF THE DRAWING

FIG. 1 is a rear elevation view of an embodiment of a cleaning, treating, and/or stimulating system according to the invention for use in high pressure, low volume applications.

FIG. 2 is a front elevation view of an embodiment of a cleaning, treating, and/or stimulating system according to the invention for use in high pressure, low volume applications.

FIG. 3 is a right side elevation view of an embodiment of a cleaning, treating, and/or stimulating system according to the invention for use in low pressure, high volume applications.

FIG. 4 is a left side elevation view of an embodiment of a cleaning, treating, and/or stimulating system according to the invention for use in high pressure, low volume applications.

FIG. 5 is a front elevation view of an embodiment of a cleaning, treating, and/or stimulating system according to the invention for use in low pressure, high volume applications.

FIG. 6 is a rear elevation view of an embodiment of a cleaning, treating, and/or stimulating system according to the invention for use in low pressure, high volume applications.

FIG. 7 is a left side elevation view of an embodiment of a cleaning, treating, and/or stimulating system according to the invention for use in low pressure, high volume applications.

FIG. 8 is a right side elevation view of an embodiment of a cleaning, treating, and/or stimulating system according to the invention for use in high pressure, low volume applications.

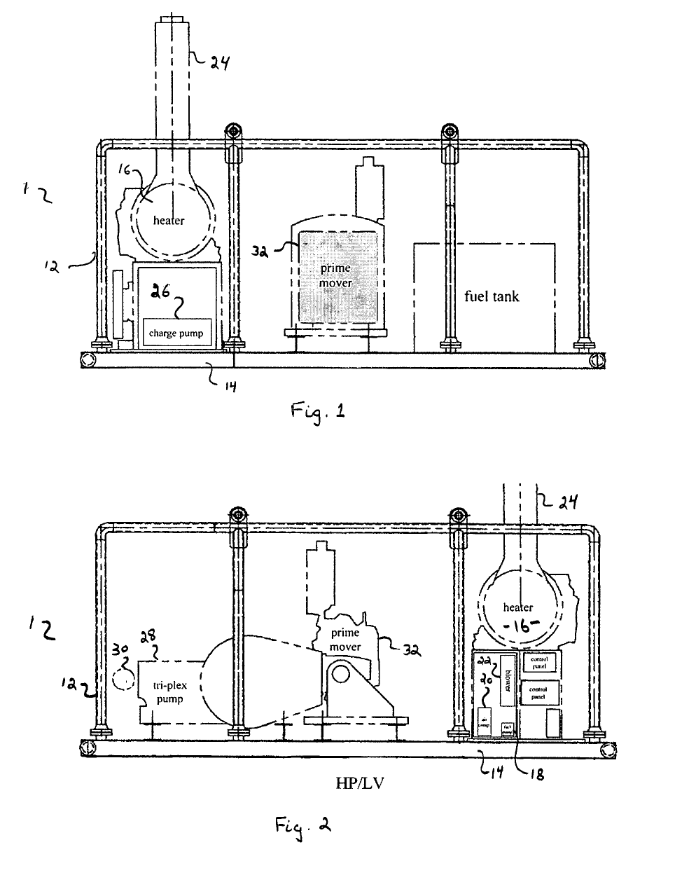

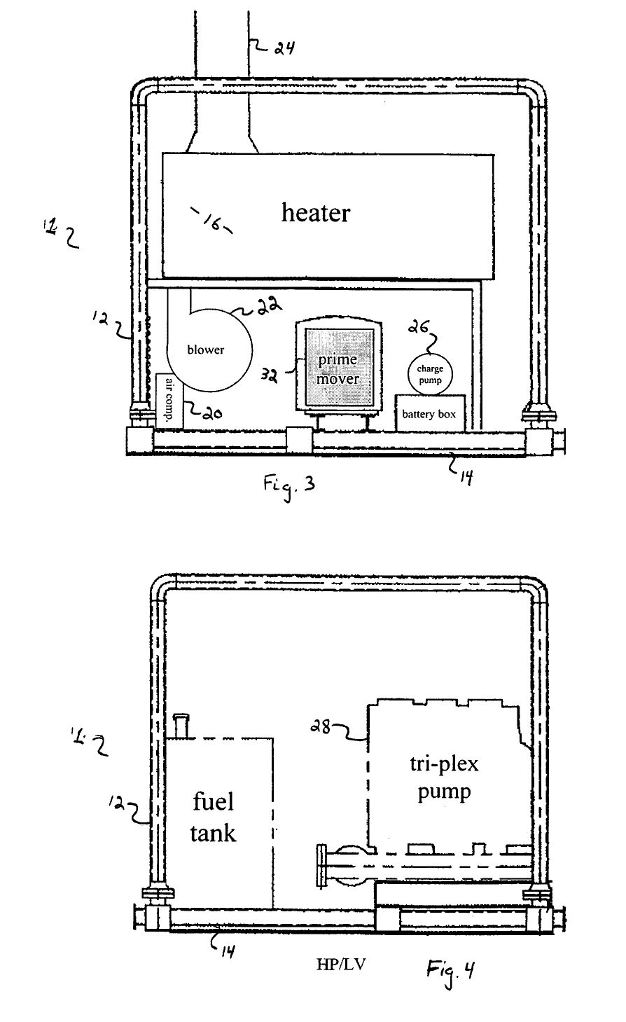

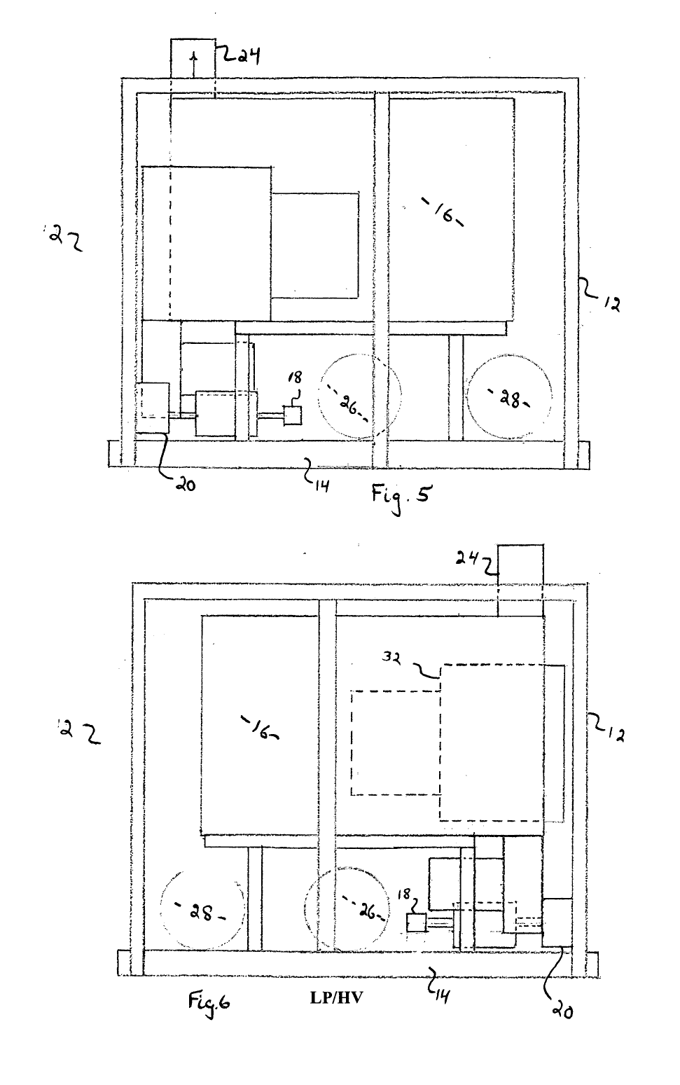

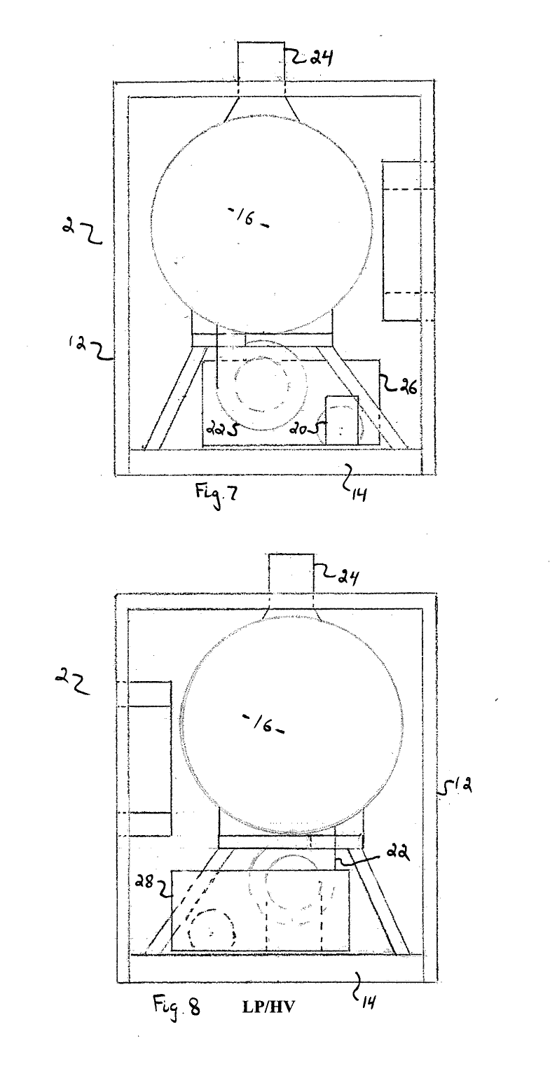

### DETAILED DESCRIPTION OF THE INVENTION

Thermal fluid heater 16, preferably a single-pass heater, capable of generating between approximately 750 k Btu and approximately 12 MM Btu of energy to heat sufficiently a working fluid at the desired pressure and volume flow rate, depending on a particular desired application, has an array of plates and coils that transfer heat to the working fluid. A preferred thermal fluid heater for a low pressure, high volume application is a Gentex 7M model single-pass thermal heater, which can produce 7 MM Btu of heat to clean economically an approximately 2,200 barrel tank at a temperature between ambient and about 350 to 400 degrees F. at a volume flow rate of up to about 200 gallons per minute (about 4½ barrels per minute) and a pressure typically between approximately 25 psi and approximately 200 psi. The pressure of the working fluid can be adjusted by adjusting the output of discharge pump 28, which is attached to the heater. Tanks of up to 4,000 barrels could be cleaned with a Gentex 7M model single-pass thermal heater when used in combination with the other apparatus of the system according to the present invention.

A preferred thermal fluid heater for a high pressure, low volume application is a Gentex 3.5 M model single-pass thermal heater, which can produce 3.5 MM Btu of heat to inject heated fluids into reservoirs under pressure, including production systems such as wells, other geological formations, flow lines, transfer lines, and production or refinery equipment. High pressure, low volume applications comprise temperatures between ambient and about 350 to 400 degrees F. at a volume flow rate of up to approximately 84 gallons per minute (about 2 barrels per minute) and a pressure typically between approximately 50 psi and 10,000 psi. The working fluid can be selectively discharged from the system at between approximately 25 psi and approximately 10,000 psi at a flow rate between approximately 3 gallons per minute and approximately 84 gallons per minute, at a temperature ranging from ambient to approximately 400 degrees F. Selective discharge flow rates and pressures can be accomplished by varying the speed of prime mover 32.

The thermal fluid heater has fuel pump 18 that forces fuel through a heater nozzle and which works in sync with air compressor 20 to atomize the fuel to provide a clean mixture of air and fuel. A Viking FH432 model fuel pump or any fuel pump that can flow up to approximately 90 gallons per hour at approximately 130 psi can be used. The system according to the invention also includes blower 22, preferably a Cincinnati Fan Model 15A, that takes ambient air and blows it into a firebox of heater 16 from which the air ultimately discharges air out of exhaust stack 24, as well as air compressor 20, preferably a W.W. Granger model 247B air compressor, which is used to atomize the fuel that is supplied, preferably from off of frame or skid 12. Any air compressor that provides 3.9 to 4.5 cfm could be used. Superheated air is blown across the coils of the heater that contains the pumped working fluid to heat the fluid to a sufficient temperature. The heated fluid is then discharged under sufficient pressure and at sufficient volume to accomplish a desired application. Alternatively, heater 16 could be valved off for ambient temperature applications.

The system according to the invention also includes charge pump 26 on the intake side of the heater for charging (i.e., forcing fluid through) the heater and, preferentially, discharge pump 28 that could terminate in a discharge port or a nozzle, depending on the application. Depending on the application, heater intake pump 26 could be used alone and discharge pump 28 could be valved off. For a low pressure, high volume application, the pumps are preferably Mission Magnum model centrifugal pumps having a 13″ casing and an 8″ impeller. These are space-saving pumps that bolt to a Marathon motor. These pumps in operation should be limited to 250 psi because the casing is tested to 300 psi. For a high pressure, low volume application, the pumps are preferably Peerless model centrifugal pumps having an 8″ casing and an 8″ impeller.

Prime mover 32 drives pumps 26 and 28, air compressor 20, and blower 22. In a low pressure, high volume application, prime mover 32 preferably includes four motors, one 75 HP motor to power each of the pumps, one 7½ HP motor to drive the blower, and one 3 HP motor, having a double-ended shaft producing 850 rpm, to power the fuel pump and air compressor. Alternatively, a single prime mover could be used for powering all equipment. The prime mover could be hydraulic, electric, or diesel, or a combination.

In a high pressure, low volume application, prime mover 32 preferably includes two motors, one 45 HP motor to power the charge pump, fuel pump, air compressor, and blower, and one 140 HP motor to drive a positive displacement discharge pump, preferably a triplex pump. Except for the heater, which should be a thermal fluid heater, the apparatus of the system could be electric, diesel, hydraulic, or a combination of same, which eliminates the need for fan belts, thereby eliminating alignment problems and some maintenance down time. The present invention can be operated using diesel pumps for high-pressure, low volume applications.

In operation, the system according to the invention can produce heated water to clean a mud tank on a vessel or a mud hold of a vessel. Water from overboard can be used as a working fluid, heated up to 212 degrees F., but the temperature is usually restricted to 175 degrees F. or less, and discharged at approximately 142-150 psi at approximately 96 gallons per minute for a 45 minute cleaning cycle. The prime mover motor draws a maximum of approximately 72 amps. At a higher flow rate of approximately 195-200 gallons per minute, the amperage draw rises to 187 amps. An advantage of the system according to one embodiment of the invention over conventional cleaning methods is that less wastewater is generated, better cleaning efficiency is obtained, and less confined space work is needed.

The frame or skid that holds the apparatus of the system according to various embodiments of the invention has a small enough footprint and low enough weight to be effectively portable for vessel and other offshore uses. Economies and efficiencies arise from the particular apparatus used, the combination of apparatus, and the arrangement of the apparatus. Without departing from the scope of the invention, various modifications and variations can be made that are apparent from the description of the invention, taken in conjunction with the drawing, can be learned by practice of the invention, or are apparent to a person of ordinary skill in the art. The invention is not limited to the specific embodiments described, but rather the invention is particularly pointed out in the following claims.

1. A system for cleaning, treating, and/or stimulating a reservoir in a high pressure, low volume application, comprising: (a) a thermal fluid heater capable of generating sufficient energy in the form of superheated air that is circulated through the heater to heat, up to approximately 400 degrees F., a working fluid that is forced through tubes within the heater, the heater having attached thereto a fuel pump that forces fuel through a nozzle of the heater; (b) an air compressor for compressing air and forcing the compressed air through the nozzle to atomize the fuel and create a fuel/air mixture; (c) a blower for blowing ambient air into the atomized fuel/air mixture in the heater to raise the temperature of the working fluid; (d) a charge pump on the intake side of the heater for forcing the working fluid through the heater at a pressure and volume sufficient to supply the working fluid to an outlet of the heater at a sufficient pressure and volume to clean, treat, and/or stimulate the reservoir; and (e) prime mover means for powering the pump, the air compressor and the blower; and wherein the heater, fuel pump, air compressor, blower, charge pump, and prime mover means are disposed on a portable frame or skid.

2. The system according to claim 1, further comprising: (f) a discharge pump on the outlet side of the heater to increase the pressure of the working fluid as it exits the system, and wherein the prime mover means also powers the discharge pump.

3. The system according to claim 2, wherein the charge pump and the discharge pump are positive displacement pumps.

4. The system according to claim 2, wherein the charge pump and the discharge pump are centrifugal pumps.

5. The system according to claim 2, wherein the working fluid is selectively discharged from the system at between approximately 25 psi and approximately 200 psi at a flow rate between approximately 70 gallons per minute and approximately 200 gallons per minute, at a temperature ranging from ambient to approximately 400 degrees F.

6. The system according to claim 2, wherein the working fluid is selectively discharged from the system at between approximately 25 psi and approximately 10,000 psi at a flow rate between approximately 3 gallons per minute and approximately 84 gallons per minute, at a temperature ranging from ambient to approximately 400 degrees F.

7. The system according to claim 1 wherein the portable frame or skid has a footprint no larger than 6 feet by 9 feet.

8. The system according to claim 7, wherein the portable frame or skid is no taller than 7½ feet.

9. The system according to claim 7, wherein the weight of the system, including any frame or skid, is less than 12,000 pounds.

10. A system for cleaning, treating, and/or stimulating a reservoir in a low pressure, high volume application, comprising: (a) a thermal fluid heater capable of generating sufficient energy in the form of superheated air that is circulated through the heater to heat, up to approximately 400 degrees F., a working fluid that is forced through tubes within the heater, the heater having attached thereto a fuel pump that forces fuel through a nozzle of the heater; (b) an air compressor for compressing air and forcing the compressed air through the nozzle to atomize the fuel and create a fuel/air mixture; (c) a blower for blowing ambient air into the atomized fuel/air mixture in the heater to raise the temperature of the working fluid; (d) a charge pump on the intake side of the heater for forcing the working fluid through the heater at a pressure and volume sufficient to supply the working fluid to an outlet of the heater at a sufficient pressure and volume to clean, treat, and/or stimulate the reservoir; and (e) prime mover means for powering the pump, the air compressor and the blower; and wherein the working fluid is selectively discharged from the system at between approximately 25 psi and approximately 200 psi at a flow rate between approximately 70 gallons per minute and approximately 200 gallons per minute.

11. The system according to claim 10, wherein the discharge pump on the outlet side of the heater to increase the pressure of the working fluid as it exits the system, and wherein the prime mover means also powers the discharge pump.

12. The system according to claim 11, wherein the charge pump and the discharge pump are positive displacement pumps.

13. The system according to claim 11, wherein the charge pump and the discharge pump are centrifugal pumps.

14. The system according to claim 10, wherein the heater, fuel pump, air compressor, blower, charge pump, and prime mover means are disposed on a portable frame or skid.

15. The system according to claim 14, wherein the portable frame or skid has a footprint no larger than 8 feet by 16 feet.

16. The system according to claim 14, wherein the portable frame or skid is no taller than 7½ feet.

17. The system according to claim 14, wherein the weight of the system, including any frame or skid, is less than 12,000 pounds.
